(19) United States
(12) Patent Application Publication
(10) Pub. No.: US 2008/0224053 A1
(43) Pub. Date: Sep. 18, 2008

(54) RADIATION IMAGE PICKUP DEVICE

(75) Inventor: Rui SHEN, Kanagawa (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/040,940

(22) Filed: Mar. 3, 2008

(30) Foreign Application Priority Data
Mar. 9, 2007 (JP) 2007-060565

(51) Int. Cl. G01T 1/20

(52) U.S. Cl. 250/369

(57) ABSTRACT

A radiation image pickup device receives radiation passing through a subject and outputs an image pickup signal responsive to an amount of the radiation. The radiation image pickup device comprising pixel part each of which comprising: a photoelectric conversion section comprising a lower electrode on or above a substrate, a photoelectric conversion film on or above the lower electrode, and an upper electrode on or above the photoelectric conversion film; a phosphor film on or above the upper electrode; and a signal output section, provided in the substrate corresponding to the photoelectric conversion section, that outputs a signal responsive to a charge generated in the photoelectric conversion film. The signal output section and the photoelectric conversion section have an overlap in a plan view, and the photoelectric conversion film comprises an organic photoelectric conversion material that absorbs light emitted from the phosphor film.

### BACKGROUND OF THE INVENTION

1. Field of the Invention

This invention relates to a radiation image pickup device for receiving radiation passing through a subject and outputting an image pickup signal responsive to the radiation amount.

2. Description of the Related Art

In a medical field, a radiation image pickup apparatus is used for irradiating a human body with radiation of X-rays, etc., and detecting the intensity of the radiation passing through the human body, thereby picking up an image of the inside of the human body. Such radiation image pickup apparatus are roughly classified into a direct image pickup apparatus and an indirect image pickup apparatus. The direct image pickup apparatus adopts a system of converting the radiation passing through the human body directly into an electric signal and taking out the electric signal to the outside. The indirect image pickup apparatus adopts a system of once making the radiation passing through the human body incident on a phosphor, converting the radiation into visible light, converting the visible light into an electric signal, and taking out the electric signal to the outside.

An example of a radiation image pickup device used with the indirect image pickup apparatus is disclosed in FIG. 20 (b) of JP-A-8-116044. One pixel of the radiation image pickup device is provided with a phosphor made of cesium iodide (CsI) above a substrate having a surface on which a photoelectric conversion section made up of a pair of electrodes and a photoelectric conversion film sandwiched therebetween, a capacitor for storing a charge generated in the photoelectric conversion film, and a TFT switch for converting the electrode stored in the capacitor into a voltage signal and outputting the voltage signal are arranged. In the radiation image pickup device, the photoelectric conversion film is formed of an inorganic photoelectric conversion material of amorphous silicon, etc.

The inorganic photoelectric conversion material has a broad absorption spectrum. Thus, the photoelectric conversion film of the radiation image pickup device disclosed in JP-A-8-116044 absorbs not only light emitted from the phosphor, but also a part of X rays passing through the phosphor. Consequently, a signal responsive to the absorbed X rays becomes noise and the image quality is degraded; this is a problem.

Generally, the radiation image pickup device requires that the light reception area (the area occupied by the photoelectric conversion film) be made equal to the size of the chest of a human body, for example, and the light reception area needs to be put into a large area. However, since the radiation image pickup device disclosed in JP-A-8-116044 has the photoelectric conversion film, the capacitor, and the TFT switch formed on the same plane, if an attempt is made to enlarge the light reception area, the formation region of the capacitor and the TFT switch also becomes large and the device area becomes large to some extent. If the device area becomes thus large, a large-scale manufacturing apparatus, etc., becomes necessary and the device does not become easy to manufacture.

### SUMMARY OF THE INVENTION

It is therefore an object of the invention to provide a radiation image pickup device capable of preventing an increase in the manufacturing cost, an increase in noise, and increase in the area.

According to the invention, there is provided a radiation image pickup device which receives radiation passing through a subject and outputs an image pickup signal responsive to an amount of the radiation, the radiation image pickup device comprising a plurality of pixel parts, each of said plurality of pixel parts comprising: a photoelectric conversion section comprising a lower electrode on or above a substrate, a photoelectric conversion film on or above the lower electrode, and an upper electrode on or above the photoelectric conversion film; a phosphor film on or above the upper electrode; and a signal output section, provided in the substrate corresponding to the photoelectric conversion section, that outputs a signal responsive to a charge generated in the photoelectric conversion film, wherein the signal output section of each of the pixel parts and the photoelectric conversion section of each of the pixel parts have an overlap in a plan view, and wherein the photoelectric conversion film comprises an organic photoelectric conversion material that absorbs light emitted from the phosphor film.

In the radiation image pickup device of the invention, an absorption peak wavelength of the organic photoelectric conversion material in a visible range may be substantially identical with an light emission peak wavelength of the phosphor film relative to the radiation in the visible range.

In the radiation image pickup device of the invention, the organic photoelectric conversion material is a quinacridone-based organic compound or a phthalocyanine-based organic compound.

In the radiation image pickup device of the invention, the phosphor film may comprise cesium iodide.

In the radiation image pickup device of the invention, the radiation may be X rays.

In the radiation image pickup device of the invention, the radiation may be X rays, the organic photoelectric conversion material may comprise quinacridone, and the phosphor film may comprise cesium iodide to which titanium is added.

In the radiation image pickup device of the invention, the lower electrode may be divided for each of the pixel parts, and the photoelectric conversion film, the upper electrode, and the phosphor film may be made common to the plurality of pixel parts.

In the radiation image pickup device of the invention, the upper electrode may be ITO.

The radiation image pickup device of the invention may further comprise a first charge blocking film between the lower electrode and the photoelectric conversion film, wherein the first charge blocking film suppresses pouring of charge into the photoelectric conversion film from the lower electrode when a bias voltage is applied to a portion between the lower electrode and the upper electrode.

The radiation image pickup device of the invention may further comprise a second charge blocking film between the upper electrode and the photoelectric conversion film, wherein the second charge blocking film suppresses pouring of charge into the photoelectric conversion film from the upper electrode when a bias voltage is applied to a portion between the lower electrode and the upper electrode.

### BRIEF DESCRIPTION OF THE DRAWINGS

FIG. 1 is a schematic sectional view to show the schematic configuration of the portion of three pixels of a radiation image pickup device of an embodiment of the invention.

### DETAILED DESCRIPTION OF THE INVENTION

Referring now to the accompanying drawing, there is shown an embodiment of the invention.

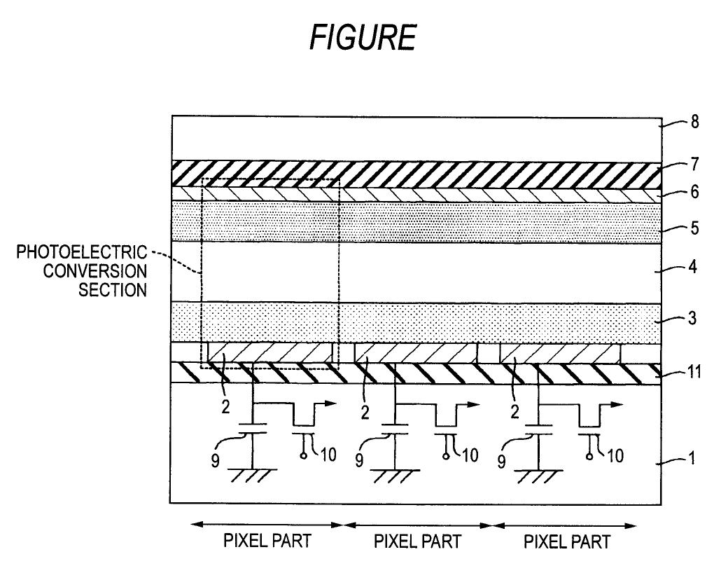

FIG. 1 is a schematic sectional view to show the schematic configuration of the portion of three pixels of a radiation image pickup device of an embodiment of the invention.

One pixel part of the radiation image pickup device includes a lower electrode 2 formed through an insulating film 11 above a substrate 1 of a semiconductor substrate, a quartz substrate, a glass substrate, etc., (here, a glass substrate), an electron blocking film 3 formed on the lower electrode 2, a photoelectric conversion film 4 formed on the electron blocking film 3, a hole blocking film 5 formed on the photoelectric conversion film 4, an upper electrode 6 formed on the hole blocking film 5, a transparent insulating film 7 of SiO₂, SiN, etc., formed on the upper electrode 6, and a phosphor film 8 formed on the transparent insulating film 7. The lower electrode 2, the upper electrode 6, and the electron blocking film 3, the photoelectric conversion film 4, and the hole blocking film 5 sandwiched between the lower electrode 2 and the upper electrode 6 make up a photoelectric conversion section.

The phosphor film 8 is a film of a phosphor for converting radiation incident on the phosphor film from above into visible light and emitting the light. Preferably, the wave range of light emitted by the phosphor contains a wave range of green to enable the radiation image pickup device to pick up a monochrome image. Therefore, preferably the phosphor used for the phosphor film 8 contains cesium iodide (CsI) when the radiation is X rays; particularly preferably, CsI (Ti) with an emission spectrum at the X-ray irradiating time extended to 420 nm to 600 nm (cesium iodide to which titanium is added) is used. The light emission peak wavelength of CsI (Ti) in a visible range is 565 nm.

The upper electrode 6 is formed of a conductive material transparent to at least the luminous wavelength of the phosphor film 8 because it needs to allow light to be incident on the photoelectric conversion film 4. A transparent conducting oxide (TCO) having high transmittance of visible light and a low resistance value can be used as a material of the upper electrode 6. A metal thin film of Au, etc., can also be used. However, if an attempt is made to obtain transmittance 90% or more, the resistance value grows extremely and thus the TCO is preferred. As the TCO, particularly ITO, IZO, AZO, FTO, SnO₂, TiO₂, ZnO₂, etc., can be used preferably; among them, ITO is most preferable from the viewpoint of process simplicity, low resistance properties, and transparency. The upper electrode 6 is formed of one layer common to all pixel parts, but may be divided each for each pixel part.

The lower electrode 2 is a thin film divided for each pixel part and is formed of a transparent or opaque conductive material. Aluminum, silver, etc., can be used as a material of the lower electrode 2.

The photoelectric conversion film 4 contains an organic photoelectric conversion material, absorbs light emitted from the phosphor film 8, and generates a charge responsive to the absorbed light. The photoelectric conversion film 4 is formed of one layer common to all pixel parts, but may be divided each for each pixel part. To most efficiently absorb light emitted from the phosphor film 8, preferably the absorption peak wavelength of the organic photoelectric conversion material forming the photoelectric conversion film 4 is almost the same as the light emission peak wavelength of the phosphor film 8. Ideally, the absorption peak wavelength of the organic photoelectric conversion material and the light emission peak wavelength of the phosphor film 8 completely match; however, if the difference therebetween is within 5 nm, the light emitted from the phosphor film 8 can be absorbed sufficiently. As an organic photoelectric conversion material capable of satisfying such a condition, a quinacridone-based organic compound and a phthalocyanine-based organic compound can be named. For example, since the absorption peak wavelength of quinacridone in a visible range is 560 nm, quinacridone is used as the organic photoelectric conversion material and CsI (Ti) is used as the material of the phosphor film 8, whereby it is made possible to place the above-mentioned difference within 5 nm and the charge amount generated in the photoelectric conversion film 4 can be almost maximized.

The photoelectric conversion section contained in each pixel part may contain at least the lower electrode 2, the photoelectric conversion film 4, and the upper electrode 6. In such a photoelectric conversion section, a predetermined bias voltage can be applied to the portion between the upper electrode 6 and the lower electrode 2, thereby moving one of hole and electron of charge generated in the photoelectric conversion film 4 to the upper electrode 6 and the other to the lower electrode 2. In the embodiment, it is assumed that wiring is connected to the upper electrode 6 and a bias voltage is applied through the wiring to the upper electrode 6. It is also assumed that the polarity of the bias voltage is determined so that the electron generated in the photoelectric conversion film 4 moves to the upper electrode 6 and the hole moves to the lower electrode 2; however, the polarity may be opposite.

The electron blocking film 3 is provided for suppressing an increase in dark current as an electron is poured into the photoelectric conversion film 4 from the lower electrode 2 when a bias voltage is applied to the portion between the lower electrode 2 and the upper electrode 6.

An electron donative organic material can be used for the electron blocking film 3. Specifically, an aromatic diamine compound of N, N-bis (3-methylphenyl)-(1,1′-biphenyl)-4,4′-diamine (TPD), 4,4′-bis (N-(naphthyl)-N-phenyl-amino]biphenyl (α-NPD), etc., oxazole, oxadiazole, triazole, imidazole, imidasolone, a stilbene derivative, a pyrazoline derivative, tetrahydroimidazole, polyarylalkane, butadiene, 4,4′,4″-tris (N-(3-methylphenyl)N-phenyl amino) triphenyl amine (m-MTDATA), porphin, TPP copper, phthalocyanine, copper phthalocyanine, a porphyrin compound such as titanium phthalocyanine oxide, a triazole derivative, an oxadiazole derivative, an imidazole derivative, apolyarylalkanea derivative, a pyrazoline derivative, a pyrazolone derivative, a phenylenediamine derivative, an aryl amine derivative, an amino substitution chalcone derivative, an oxazole derivative, a styryl anthracene derivative, a fluorenone derivative, a hydrazone derivative, a silazane derivative, etc., can be used as a monomeric material, and a polymer of phenylenevinylene, fluorine, carbazole, indole, pyrene, pyrrole, picoline, thiophene, acetylene, diacetylene, etc., or a derivative thereof can be used as a polymeric material.

Preferably, the thickness of the electron blocking film 3 is 10 nm or more and 200 nm or less; more preferably, the thickness is 30 nm or more and 150 nm or less; particularly preferably, the thickness is 50 nm or more and 100 nm or less. If the thickness is too thin, the dark current suppression effect is degraded; if the thickness is too thick, the photoelectric conversion effect of the photoelectric conversion section is degraded.

Selection of the material actually used for the electron blocking film 3 is defined by the material of an adjacent electrode and the material of an adjacent photoelectric conversion film. Preferably, the material has an electron affinity (Ea) larger than the work function (Wf) of the material of the adjacent electrode by 1.3 eV or more and has ionization potential (Ip) equal to or smaller than Ip of the material of the adjacent photoelectric conversion film.

The hole blocking film 5 is provided for suppressing an increase in dark current as a hole is poured into the photoelectric conversion film 4 from the upper electrode 6 when a bias voltage is applied to the portion between the lower electrode 2 and the upper electrode 6.

An electron receptive organic material can be used for the hole blocking film 5. Fullerene or carbon nanotube including C60, C70, a derivative thereof, an oxadiazole derivative of 1,3-bis (4-tert-butylphenyl-1,3,4-oxadiazolyl)phenylene (OXD-7), etc., an anthraxquinodimethan derivative, a diphenyl quinone derivative, bathocuproin, bathophenanthroline, a derivative thereof, a triazole compound, a tris (8-hydroxyquinolinate) aluminum complex, a bis (4-methyl-8-quinolinate) aluminum complex, a distyryl arylene derivative, a sylol compound, etc., can be used as the electron receptive organic material.

Preferably, the thickness of the hole blocking film 5 is 10 nm or more and 200 nm or less; more preferably, the thickness is 30 nm or more and 150 nm or less; particularly preferably, the thickness is 50 nm or more and 100 nm or less. If the thickness is too thin, the dark current suppression effect is degraded; if the thickness is too thick, the photoelectric conversion effect of the photoelectric conversion section is degraded.

Selection of the material actually used for the hole blocking film 5 is defined by the material of an adjacent electrode and the material of an adjacent photoelectric conversion film. Preferably, the material has ionization potential (Ip) larger than the work function (Wf) of the material of the adjacent electrode by 1.3 eV or more and has an electron affinity (Ea) equal to or larger than Ea of the material of the adjacent photoelectric conversion film.

To set the bias voltage so that of the charge generated in the photoelectric conversion film 4, the hole moves to the upper electrode 6 and the electron moves to the lower electrode 2, the positions of the electron blocking film 3 and the hole blocking film 5 may be made opposite. Both of the electron blocking film 3 and the hole blocking film 5 need not necessarily be provided; if either is provided, a measure of dark current suppression effect can be produced.

Formed on the surface of the substrate 1 below the lower electrode 2 of each pixel part are a capacitor 9 functioning as a charge storage section for storing the charge moved to the lower electrode 2 and a field effect transistor 10 functioning as a signal output section for converting the charge stored in the capacitor 9 into a voltage signal and outputting the voltage signal. The region where the capacitor 9 and the field effect transistor 10 are formed has a portion overlapping the lower electrode 2 in a plan view. To minimize the flat area of the radiation image pickup device, it is desirable that the region should be covered completely with the lower electrode 2.

The capacitor 9 is electrically connected to the corresponding lower electrode 2 by a plug (not shown) of a conductive material formed piercing the insulating film 11, whereby the charge gathered in the lower electrode 2 can be moved to the capacitor 9. For example, amorphous silicon can be used as a material of the field effect transistor 10.

For example, if the substrate 1 is an n-type semiconductor substrate, an n-type impurity diffusion region may be formed in a p well layer formed on the surface of the n-type semiconductor substrate below the lower electrode 2 and may be used as a charge storage section, the charge storage section and the lower electrode 2 may be connected by a conductive material, and a MOS circuit may be formed in the n-type semiconductor substrate and on the surface thereof and may be used as a signal output section.

The operation of the described radiation image pickup device is as follows:

If a human body is irradiated with X rays and the X rays passing through the human body are incident on the phosphor film 8, light having a wavelength of 420 to 600 nm is emitted from the phosphor film 8 and is incident on the photoelectric conversion film 4. If light in a wave range of green of the incidence light is absorbed in the photoelectric conversion film 4, a charge is generated in the photoelectric conversion film 4 and a hole of the generated charge moves to the lower electrode 2 and is stored in the capacitor 9. The hole stored in the capacitor 9 is converted into a voltage signal through the field effect transistor 10 and the voltage signal is output. A monochrome image of photographing the inside of the human body is provided according to the voltage signal obtained from each pixel part.

Thus, according to the radiation image pickup device of the embodiment, each pixel part is formed with the charge storage section and the signal output section below the photoelectric conversion section, so that the device area can be drastically reduced as compared with the configuration wherein the photoelectric conversion section, the charge storage section, and the signal output section are formed on the same plane like the device disclosed in JP-A-8-116044.

According to the radiation image pickup device of the embodiment, the organic photoelectric conversion material where the absorption peak wavelength can be easily controlled is used as the material of the photoelectric conversion film 4 and thus it is made possible to almost match the light emission peak wavelength of the phosphor film 8 and the absorption peak wavelength of the photoelectric conversion film 4 with each other, and the light emitted from the phosphor can be absorbed with no waste.

According to the radiation image pickup device of the embodiment, the organic photoelectric conversion material having a sharp absorption spectrum in the visible region rather than a broad absorption spectrum like an inorganic photoelectric conversion material is used as the material of the photoelectric conversion film 4 and thus any light other than the visible light emitted by the phosphor film 8 is scarcely absorbed in the photoelectric conversion film 4 and noise occurring as X rays are absorbed in the photoelectric conversion film 4 can be lessened as much as possible. Such an effect can be provided by setting the absorption spectrum of the photoelectric conversion film 4 to an absorption spectrum for absorbing visible light and scarcely absorbing infrared light.

According to the radiation image pickup device of the embodiment, after the charge storage section, the signal output section, and the lower electrode 2 are formed, the components can be formed simply by forming a film of a material on the full face of the substrate. Thus, if the area of the radiation image pickup device is to be upsized, the need for much increasing the microminiaturization process is eliminated, so that the radiation image pickup device can be manufactured easily.

According to the radiation image pickup device of the embodiment, a dark current can be suppressed by the electron blocking film 3 and the hole blocking film 5, so that it is made possible to pick up an image with high quality. To use the radiation image pickup device for medical care, the area of the radiation image pickup device becomes very large. If the area is large, it is conceivable that the charge poured into the photoelectric conversion film 4 from the lower electrode 2 and the upper electrode 6 will also become much. Therefore, aggressive suppressing of a dark current by providing the electron blocking film 3 and the hole blocking film 5 becomes effective.

According to the invention, there can be provided a radiation image pickup device capable of preventing an increase in the manufacturing cost, an increase in noise, and increase in the area.

The entire disclosure of each and every foreign patent application from which the benefit of foreign priority has been claimed in the present application is incorporated herein by reference, as if fully set forth.

What is claimed is:

1. A radiation image pickup device which receives radiation passing through a subject and outputs an image pickup signal responsive to an amount of the radiation,
the radiation image pickup device comprising a plurality of pixel parts,
each of said plurality of pixel parts comprising:
a photoelectric conversion section comprising a lower electrode on or above a substrate, a photoelectric conversion film on or above the lower electrode, and an upper electrode on or above the photoelectric conversion film;
a phosphor film on or above the upper electrode; and
a signal output section, provided in the substrate corresponding to the photoelectric conversion section, that outputs a signal responsive to a charge generated in the photoelectric conversion film,
wherein the signal output section of each of the pixel parts and the photoelectric conversion section of each of the pixel parts have an overlap in a plan view, and
wherein the photoelectric conversion film comprises an organic photoelectric conversion material that absorbs light emitted from the phosphor film.

2. The radiation image pickup device as claimed in claim 1,
wherein an absorption peak wavelength of the organic photoelectric conversion material in a visible range is substantially identical with an light emission peak wavelength of the phosphor film relative to the radiation in the visible range.

3. The radiation image pickup device as claimed in claim 1,
wherein the organic photoelectric conversion material is a quinacridone-based organic compound or a phthalocyanine-based organic compound.

4. The radiation image pickup device as claimed in claims 1,
wherein the phosphor film comprises cesium iodide.

5. The radiation image pickup device as claimed in claim 1,
wherein the radiation is X rays.

6. The radiation image pickup device as claimed in claim 1,
wherein the radiation is X rays,
the organic photoelectric conversion material comprises quinacridone, and
the phosphor film comprises cesium iodide to which titanium is added.

7. The radiation image pickup device as claimed in claim 1,
wherein the lower electrode is divided for each of the pixel parts, and
the photoelectric conversion film, the upper electrode, and the phosphor film are made common to the plurality of pixel parts.

8. The radiation image pickup device as claimed in claim 1,
wherein the upper electrode is ITO.

9. The radiation image pickup device as claimed in claim 1, further comprising a first charge blocking film between the lower electrode and the photoelectric conversion film,
wherein the first charge blocking film suppresses pouring of charge into the photoelectric conversion film from the lower electrode when a bias voltage is applied to a portion between the lower electrode and the upper electrode.

10. The radiation image pickup device as claimed in claim 1, further comprising a second charge blocking film between the upper electrode and the photoelectric conversion film,
wherein the second charge blocking film suppresses pouring of charge into the photoelectric conversion film from the upper electrode when a bias voltage is applied to a portion between the lower electrode and the upper electrode.
